(19) United States
(12) Patent Application Publication
(10) Pub. No.: US 2020/0118062 A1
(43) Pub. Date: Apr. 16, 2020

(54) Auditable Networked Enterprise Oversight System

(71) Applicant: TRAC Consulting, LLC, San Diego, CA (US)

(72) Inventor: Anthony Eugene Greenwell, Ramona, CA (US)

(21) Appl. No.: 16/554,480

(22) Filed: Aug. 28, 2019

Related U.S. Application Data
(60) Provisional application No. 62/723,984, filed on Aug. 28, 2018.

(51) Int. Cl. G06Q 10/08; G06Q 10/10; G06Q 10/06; G06Q 40/00; G06Q 50/30; G06K 7/14; H04W 4/021; G01S 19/51

(52) U.S. Cl. CPC G06Q 10/087; G06Q 10/1091; G06Q 10/063114; G06Q 40/125; H04W 84/12; G06K 7/1413; H04W 4/021; G01S 19/51; G06Q 50/30

(57) ABSTRACT

Disclosed is an auditable networked shipyard capable of building and/or repairing ships with real-time progress and cost tracking, as well as instant and efficient auditability. The shipyard provides standard shipyard components such as cranes, drydocks or syncrolifts, tools, and consumable items such as paint and parts. The shipyard is configured to provide welding, machining, pipefitting, electrical, rigging, and other relevant functions for the building and/or repair of ships. In order to match resources to functions, track availability of resources, and generally oversee operations of the shipyard, a totally reliable auditable contracting enterprise resource planning system (“TRAC system”) is configured to allow real-time oversight of each work item on each job of a business in the ship repair or ship support industry. The TRAC system consolidates all business management and production functions into a single enterprise resource planning (“ERP”) system.

### RELATED APPLICATION

This application claims priority to U.S. Provisional Patent Application Ser. No. 62/723,984 for an “Auditable Networked Enterprise Oversight System,” filed Aug. 28, 2018, and currently co-pending, the entirety of which is incorporated herein by reference.

### FIELD OF THE INVENTION

The present invention pertains generally to an enterprise with networked job and material tracking capabilities. More particularly, the present invention pertains to an enterprise with distributed application system and a centralized database for use in resource planning. The Present invention is particularly, but not exclusively, useful as a shipyard with a networked oversight tool to manage business operations in the ship repair and support industries.

### BACKGROUND OF THE INVENTION

Shipbuilding, ship repair, and ship support are complicated industries, due in part to the complexity of modern vessels, the harsh maritime environment in which the vessels operate, and government regulations applicable to the industry. Additional requirements and corresponding complexity arise when military contracts are involved.

The operation of the shipyard, the management of pollution and compliance with environmental regulations, the welding, the pipefitting, the rigging, and the variety of other tasks in the ship repair industry require a broad array of skilled workers. Safety rules must be implemented and followed. Tools and equipment must be maintained in operable and safe condition. Quality control must be implemented. And between the many tasks and many workers, time and materials must be tracked for each job in order to properly invoice clients.

Recruitment is also becoming an issue as those entering the workforce are treating skilled labor jobs as undesirable, thus putting pressure on the human resources side of shipyard management.

Due to the increasing complexity of running a modern shipyard, it has become impossible for a senior manager to effectively oversee the business without the aid of technology. Moreover, due to the uniqueness of the industry, including the variety of skilled workers, tools, and unique challenges, generic management software has not been able to address the formidable management challenges faced by ship repair and support businesses. The current state of the art simply would not allow a senior manager to see an overview of the entire business and identify a problem or area of improvement in a specific department or in the interface between multiple departments.

In light of the above, it would be advantageous to provide a shipyard configured for centralized real-time tracking of the use of goods and labor distributed through various portions of the shipyard. It would be further advantageous to provide distributed tool for a business in the ship repair or ship support industry that provides appropriate applications for each department in an integrated system providing real-time traceability of each work item on each job to management.

### SUMMARY OF THE INVENTION

Disclosed is an auditable networked shipyard capable of building and/or repairing ships with real-time progress and cost tracking, as well as instant and efficient auditability. The shipyard provides standard shipyard components such as cranes, drydocks or syncrolifts, tools, and consumable items such as paint and parts. The shipyard is configured to provide welding, machining, pipefitting, electrical, rigging, and other relevant functions for the building and/or repair of ships. In order to match resources to functions, track availability of resources, and generally oversee operations of the shipyard, a totally reliable auditable contracting enterprise resource planning system (“TRAC system”) is configured to allow real-time oversight of each work item on each job of a business in the ship repair or ship support industry. The TRAC system consolidates all business management and production functions into a single enterprise resource planning (“ERP”) system.

The TRAC system comprises a centralized database on at least one server, and a plurality of workstations running TRAC software. In preferred embodiments, some or all of the workstations comprise specialized hardware, such as hardware for biometric authentication, bar code scanners, and other hardware for performing specialized tasks of the TRAC system.

The one or more servers comprise a server operating system and an SQL database. In its simplest embodiment, the server portion of the TRAC system consists of a single server running an SQL database. Alternative embodiments directed to greater reliability, speed, or related concerns comprise an SQL database replicated across multiple servers. A load balancer may be used to ensure that the workstations communicate with the appropriate server for optimum performance.

The TRAC system comprises application modules comprising a job costing module, an invoicing module, a purchasing module, an inventory module, a human resources management module, a project management module, a progress module, a timekeeping module, and a quality assurance module. The modules form a suite of integrated applications that can collect, store, manage, and interpret real-time data and allow different departments to work both independently and concurrently.

The job costing module receives and stores job cost estimate data from a user, forwards the data to other departments for approval, and creates an official job once a customer accepts an estimate.

The invoicing module allows for the tracking of firm fixed price, time and material, mixed billing, and percent completion. Integration with QuickBooks Pro accounting software is supported. The module generates invoices based on each individual work item or type of billing within an invoice.

The purchasing module allows users to generate purchase requisitions and purchase orders, route purchase requisitions and purchase orders for approval, track purchase orders, and run reports.

The inventory module allows users to manage receipt, inspection, reporting, and disbursement of materials and equipment. The module is configured to separately track purchased and customer-owned consumables, tools, and assets. Integration of consumable inventory levels directly into QuickBooks Pro accounting software is supported. In preferred embodiments, a bar code reader facilitates rapid and efficient tracking of inventory.

The human resources management module tracks employee hours, benefits, and training, and prepares and tracks 1099 and 542 forms for independent contractors.

The project management module allows users to project anticipated sales, evaluate costs against estimates, run reports, plan resources, track email communication by job, and track certificates of completion. The module allows the user to prepare daily work assignments for employees broken down at the job and work item level and code employee hours by a given employee or the type of work the employee performed.

The progress module allows users to schedule and monitor the progress of a job, including comparing estimated performance levels to actual performance levels and running progress reports.

The timekeeping module tracks employee work hours and is configured for integration with QuickBooks Pro accounting software. Preferred embodiments use radio-frequency identification (“RFID”) technology, such as near field communication (“NFC”) tags, or biometric identification hardware, such as a fingerprint reader, to identify employees and track their work hours.

The Quality Assurance module allows users to maintain a technical library, maintain quality management system manuals and safety manuals, maintain test and inspection plans, maintain objective quality evidence, check out tools and track calibration, and perform reporting and auditing to ensure continuous process improvement.

Although the TRAC system is disclosed in an exemplary preferred embodiment as part of a fully automated shipyard, it is not limited to shipyards alone. The TRAC system is useful for facilitating resource planning and oversight in any large, complex enterprise. The TRAC system is particularly suited for management of highly technical endeavors, including those engaged in repair, maintenance, and manufacturing, and it facilitates highly efficient handling of project management and contract process workflow.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates the components of a networked auditable shipyard of a preferred embodiment of the present invention;

FIG. 2 illustrates of a preferred embodiment of a TRAC system showing a server, a plurality of workstations, and specialized hardware;

FIG. 3 illustrates a preferred embodiment of a TRAC system server;

FIG. 4 illustrates a preferred embodiment of a TRAC system workstation;

FIG. 5 illustrates a set of modules present in preferred embodiments of the TRAC system;

FIG. 6 illustrates exemplary portions of the data stored by a preferred embodiment of a job costing module of a TRAC system;

FIG. 7 illustrates user-accessible procedures of the job costing module;

FIG. 8 illustrates user-accessible procedures of the invoicing module;

FIG. 9 illustrates user-accessible procedures of the purchasing module;

FIG. 10 illustrates user-accessible procedures of the inventory module;

FIG. 11 illustrates exemplary data stored in association with an inventoried tool;

FIG. 12 illustrates user-accessible procedures of the human resources management module;

FIG. 13 illustrates user-accessible procedures of the project management module;

FIG. 14 illustrates user-accessible procedures of the progress module;

FIG. 15 illustrates user-accessible procedures of the timekeeping resources management module;

FIG. 16 illustrates user-accessible procedures of the quality assurance module;

FIG. 17 illustrates a preferred embodiment of the general user interface of a TRAC system; and

FIG. 18 illustrates a timekeeping apparatus used in a preferred embodiment of a TRAC system and having a fixed RFID reader;

FIG. 19 illustrates a timekeeping apparatus used in a preferred embodiment of a TRAC system and having a fixed RFID tag;

FIG. 20 illustrates a timekeeping apparatus used in a preferred embodiment of a TRAC system and having a mobile RFID reader and a mobile RFID tag;

FIG. 21 illustrates a timekeeping system used in a preferred embodiment of a TRAC system and having a geo-fence.

### DETAILED DESCRIPTION

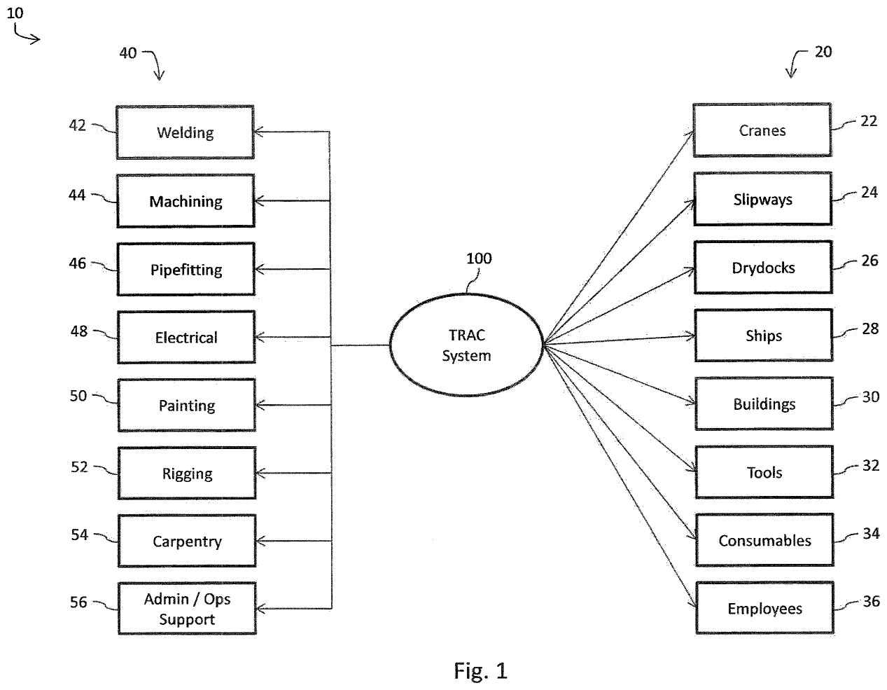

Referring initially to FIG. 1, a diagram of an auditable networked shipyard 10 is shown. A non-exhaustive list of structural components 20 present in an exemplary auditable networked shipyard 10 is shown, and includes cranes 22, slipways 24, drydocks 26, ships 28, buildings 30, tools 32, consumables 34, and employees 36. In the listing of each component, it should be understood that the plural is intended to comprise the singular—that is, a smaller shipyard 10 may have only a single crane 22, and/or a single drydock 26, and so forth. The use of the term “drydock” is contemplated to include traditional drydocks (otherwise known as “graving docks”), floating drydocks, and alternative tools for removing a ship from the water, such as syncrolifts. A slipway 24 will not be present in some shipyards 10, including some that do not build ships, but only repair ships.

The structural components 20 are not always in the same location, meaning that they are not always geographically contiguous. For example, an auditable networked shipyard 10 may have offices (comprising one or more buildings 30) in a town or city, separated from and non-contiguous to its waterfront components (such as drydocks 26 and cranes 22).

The structural components 20 are used in support of the functional elements 40 of the shipyard, or, in the case of ships 28, are the objects of the functions performed by the functional elements 40, which correspond to the various trades practiced in the shipyard, as well as administration and management. As with the structural components 20, a non-exhaustive list of functional elements 40 of a shipyard 10 is provided, and includes welding 42, machining 44, pipefitting 46, electrical 48, painting 50 (including sandblasting), rigging 52, carpentry 54, and administration and operations support 56. These functional elements 40 form logical divisions of the shipyard 10 which use the structural components 20 to perform the work of the shipyard 10 in building, maintaining, and repairing ships.

A Totally Reliable Auditable Contracting enterprise resource planning system (“TRAC system”) 100 comprises a network, computers, and specialized hardware providing job tracking and management capabilities to each of the functional elements 40, thus creating an efficient management link between administration and operations support 56 and the other functional elements 40 of the shipyard 10. The TRAC system 100 is used by administration and operations support 56, in conjunction with the other functional elements 40, to track and manage the use of the structural components 20. The TRAC system 100, as directed by management, indicates the jobs to be done and allocates resources to avoid conflicts. Thus the TRAC system 100 causes the functional elements 40 to operate efficiently, and allows administration and operations support 56 to monitor the progress and cost of jobs in real-time.

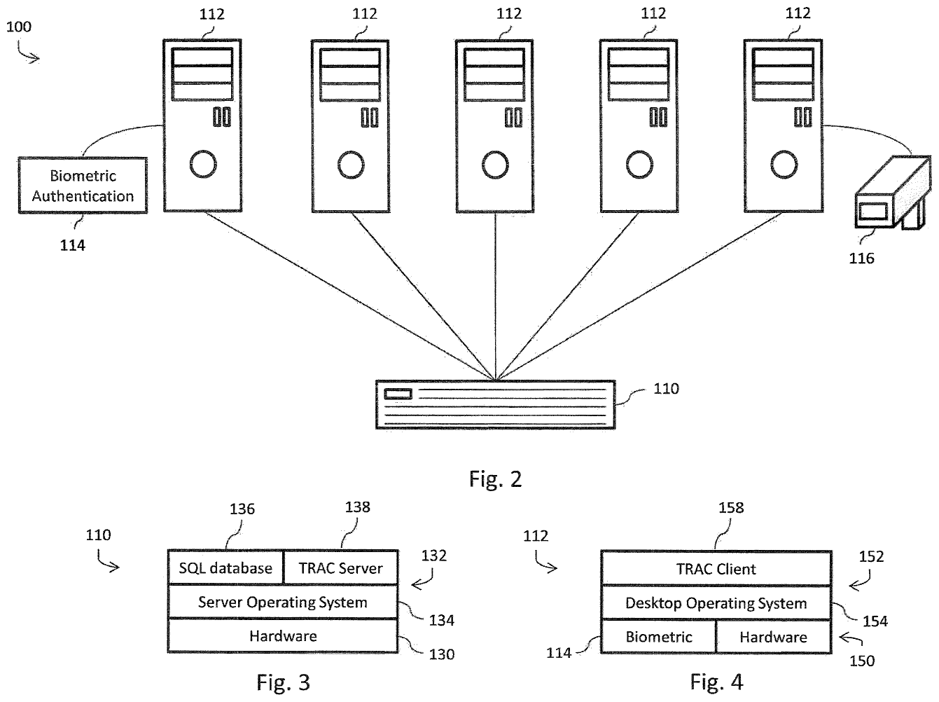

Referring now to FIG. 2, a preferred embodiment of a TRAC system 100 is illustrated at the hardware layer. The TRAC system 100 comprises at least one server 110, which provides a central data store for the TRAC system. Where reliability and uptime are particularly of concern, two servers 110 are used for redundancy, with the second server 110 acting as a failover to keep the TRAC system 100 operational in the event of a failure of the first server 110. Likewise, more than two servers 110 may be used for additional redundancy. Two or more servers 110 may also be used with a load balancer, particularly in large operations, to provide rapid responsiveness.

User-facing components of the TRAC system 100 operate on workstations 112. The TRAC system 100 is designed to be flexible with respect to the number of workstations 112, and workstations 112 may be added and removed from a TRAC system 100 as business circumstances require. The TRAC system 100 will continue to be operable while at least one server 110 and at least one workstation 112 are operative. In most circumstances, at least one workstation 112 per user of the TRAC system 100 will be present and operative.

The workstations 112 are configured to communicate with the server 110 over a computer network. In preferred embodiments, the computer network comprises a TCP-based transport layer, while the physical layer comprises one or more of twisted pair cable, fiber optics, radio signals (including WiFi and mobile data signals), and infrared, along with supporting hardware, in any combination. This allows the TRAC system 100 to operate either over the Internet or a Local Area Network (“LAN”).

In preferred embodiments, at least one biometric authentication device 114, such as a fingerprint reader, is connected to at least one workstation 112 and used to identify employees 36 in conjunction with a timekeeping module, as discussed further below. In one or more alternative embodiments, biometric authentication devices 114 are present on most or all workstations 112, and is used as a security method to authenticate users in order to access the TRAC system 100. In at least one embodiment, biometric authentication devices 114 are used for both employee 36 timekeeping and system access.

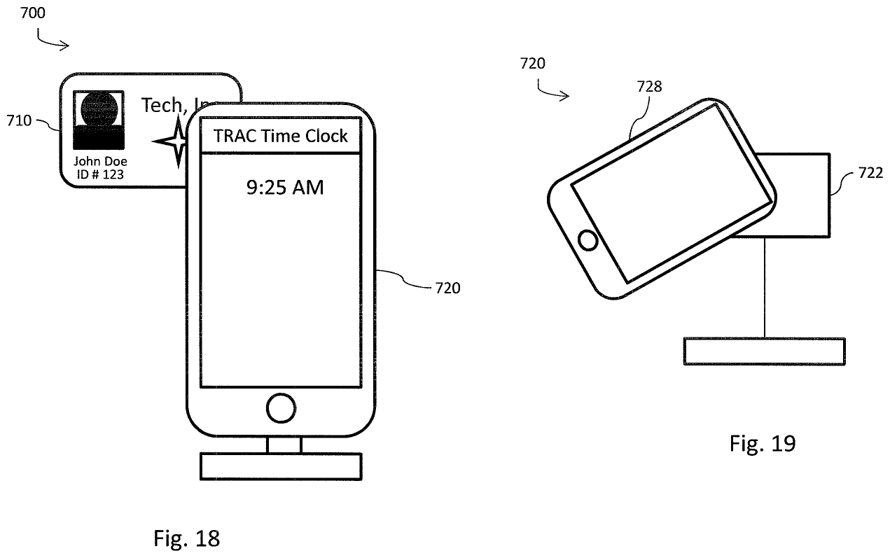

In alternate preferred embodiments, radio-frequency identification (“RFID”) technology is used in place of or along with biometric authentication devices 114, as discussed more fully below in connection with FIG. 18.

In preferred embodiments, at least one bar code reader 116 is connected to at least one workstation 112, and used for efficiency in inventory management.

Referring now to FIG. 3, the components of a server 110 are illustrated. Server 110 has a hardware layer 130 comprising a processor, volatile and non-volatile memory, power supply, network interface, and, in some embodiments, additional peripheral devices. A software layer 132 runs on the hardware layer 130 and comprises an operating system 134, a database 136, and, in some embodiments, a TRAC server process 138 configured to communicate with TRAC client processes.

Operating system 134 manages processes running on the software layer 132, and also manages access to the hardware layer 130 for those processes. A preferred embodiment of the server 110 runs a Microsoft® Windows Server operating system as the operating system 134, which allows the server 110 to be managed by on-site staff familiar with Windows branded operating systems without the need for specialized operating systems knowledge. It will be apparent to one of skill in the art that other operating systems may be used to implement the server 110, including but not limited to operating systems based on the Linux kernel, BSD or other Unix operating systems, embedded operating systems, or any operating system providing or capable of running a network stack.

Database 136 maintains the data store for the TRAC system 100. A preferred embodiment of the server 110 runs a version of Microsoft® SQL Server as database 136, thus providing a relational database that is well-integrated with the Windows Server operating systems and uses a well-known query language. Microsoft® SQL Server may also be run on a server 110 running a Linux-based operating system. Nonetheless, it will be apparent to one of skill in the art that other SQL databases, such as MySQL, PostgreSQL, and others may be used. Some alternative embodiments employ a non-SQL or a “NoSQL” database for the sake of speed, database simplicity, or flexibility in data types.

A preferred embodiment of the TRAC system 100 runs a TRAC server process 138 to communicate with workstations 112 rather than letting the workstations 112 access the database 136 directly. This allows for more fine-grained user access controls to be implemented on the server 110 rather than on workstations 112, thus improving security. By using a TRAC server process 138, preferred embodiments are also able to manage timing-related issues in updating data rather than leaving the database 136 to do so. For example, some embodiments lock a piece of data while it is accessed by a user who may write to it, prohibiting changes to the relevant portion of data by other users. Time limits ensure that a user can't indefinitely exclude others from updating the piece of data. Some embodiments will allow a user recognized as having higher authority to override another user's lock on a portion of data, thus allowing supervisors to take control of a piece of locked data that needs to be changed. Other embodiments, instead of implementing a locking system, handle “race conditions”—when a piece of data is updated by multiple users at the same time—according to an algorithm for selecting which user receives a higher priority for making the change or by selecting a user from a predetermined ranking of priorities.

Referring now to FIG. 4, the components of a workstation 112 are illustrated. Like server 110, a workstation 112 has a hardware layer 150 and a software layer 152. The hardware layer 150 comprises a processor, volatile and non-volatile memory, power supply, network interface, and, in some embodiments, additional peripheral devices. Some exemplary peripheral devices which are present in some or all workstations 112 of preferred embodiments of the TRAC system 100 include biometric authentication devices 114 and bar code readers 116.

The software layer 152 comprises an operating system 154 and a TRAC client process 158. Preferred embodiments of workstation 112 use a Microsoft® Windows “Pro” or “Professional” operating system, such as Windows 7 Professional or Windows 10 Pro as operating system 154. Nonetheless, it will be apparent to one of skill in the art that any operating system suitable for use on a networked workstation may be used, including but not limited to other Microsoft® Windows operating systems or Linux-based desktop operating systems.

The TRAC client process 158 comprises one or more processes configured to allow an authenticated user to access and use the TRAC system 100. The TRAC client process 158 works in conjunction with the server or servers 110 to provide the user with modules to manage portions of the business determined by permissions associated with the user.

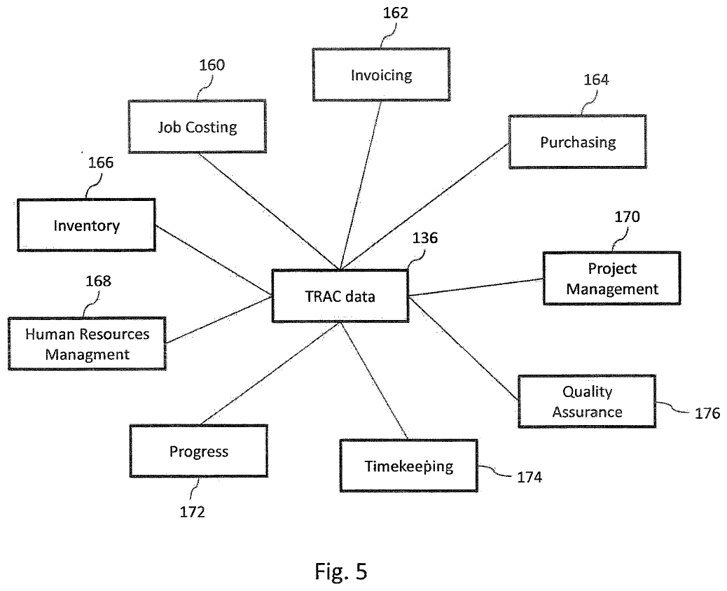

Referring now to FIG. 5, an exemplary set of modules present in preferred embodiments of the TRAC system 100 is illustrated. The modules are generally implemented in the TRAC client process 158, or, in some embodiments, the TRAC client process 158 in conjunction with the TRAC server process 138. Nonetheless, each module is dependent on the data store implemented through the database 136. The modules thus provide an organized presentation and manner of accessing the data stored in the database 136.

The illustrated modules comprise logical or conceptual divisions of certain portions of the functionality of the TRAC system 100, but the actual implementation does not always conform to the conceptual layout. That is, a procedure associated with one module might be implemented by portions of code that also implements procedures associated with another module. From a user's perspective, a feature associated with one module might be accessed from a feature associated with another module. For example, an interface for creating an invoice might be associated conceptually with one module, but accessed from a job management interface that is conceptually associated with another module.

The job costing module 160 allows users to develop detailed estimates, multi-line estimates, and job cost data for multiple jobs with multiple work items. The job costing module 160 is configured to allow a user to set up, develop, and calculate an estimate with multiple work items at a detailed level for labor, materials, inventory, tools, equipment, and subcontractors. Users can include fully burdened rates by adding general and administrative overhead, profit/fee, and fringe rates (calculated and managed by authorized users only) to labor, materials, tools, equipment, and subcontractors for each work item. The job costing module 160 also allows users to route estimates for approval by other users (e.g. contracts department, management, etc.) and return to estimating.

Preferred embodiments of the job costing module 160 maintain version control of estimates.

The job costing module 160 records, tracks, and allows for query of pertinent project data, including customer, multiple points of contact, project title, project location, project details, solicitation number, anticipated period of performance, estimate number, date, estimated likelihood of win, and supporting documents (e.g. drawings, specifications, standards, quotes, pictures, etc.).

Users may create an official job through the job costing module 160 once the customer accepts the estimate.

Additionally, users may use the job costing module 160 to maintain a database of current and potential customers that contains customer relationship management (“CRM”) capabilities, including general notes, detail fields specific to the customer, custom queries, and reports.

The invoicing module 162 allows users to invoice and track firm fixed price, time and material, mixed billing, and percent of completion. Preferred embodiments of the invoicing module 162 are configured to interface directly with external accounting software, such as QuickBooks Pro, allowing an organization to seamlessly integrate TRAC system 100 data with software already used by the organization when preparing invoices.

Using the invoicing module 162, users may reconcile sub-ledgers back to the general ledger, track costs incurred on any job at the job and work item level, and activate or deactivate an entire job or select work items in an open contract so that no costs can be applied to the job or a given work item. The invoicing module 162 is also used to charge labor, materials, inventory, tools, equipment, and subcontractors to a contract at the work item level, while separating non-allowable charges that are needed for accounting purposes. The invoicing module 162 is also used to charge materials at the work item level upon receipt and/or upon invoice from the supplier.

Features of preferred embodiments of the invoicing module 162 are the ability to generate invoices based on all work items that have been accepted and approved, but not yet billed, and to generate invoices based on each individual work item or type of billing (firm fixed price or time and materials) within an invoice.

Freight and taxes can be added to the purchase order amount when invoicing, and the purchase order can be automatically matched to receiving/inventory in order to auto-generate invoices. Moreover, multiple purchase orders can be referenced on a single invoice.

Authorized users may modify, edit, and adjust customer invoices prior to finalization, and payments can be tracked by credit card and check. The invoicing module 162 is configured to run reports at the job and/or work item level for costs incurred to date and in real time, for all open purchase orders at the job and/or work item level, and a comparison report against the estimated amounts, invoiced amounts, and/or remaining amounts.

The purchasing module 164 allows users to generate purchase requisitions and purchase orders, route purchase requisitions and purchase orders for approval, track purchase orders, and run reports. Users can use the purchasing module 164 to generate purchase requisitions and route them for approval, and to generate purchase orders after purchase requisitions have been approved and route them for approval. Purchase orders can be submitted to the vendor via email generated by the TRAC system 100. The purchasing module 164 can also be used to credit and prepare return merchandise authorizations for a purchase order or invoice that also credits the job at the work item level.

The purchasing module 164 allows users to save all purchase orders and invoices for record and viewing at any time, to view supporting documents and transactions tied to a given expense, and to adjust expense codes against the purchase order.

The inventory module 166 allows users to manage receipt, inspection, reporting, and disbursement of materials and equipment. The inventory module 166 is configured to separately track purchased and customer-owned consumables 34, tools 32, and assets (including other structural components 20).

The inventory module 166 is also configured to conduct cycle counts for purchased consumable items 34 at defined levels and manually include and exclude items on hand as needed. The module allows users to set alerts for defined re-order points for consumable items and displays the set alert to the appropriate user at the defined re-order point. Consumable 34 inventory levels are integrated by the inventory module 166 directly into external accounting software such as QuickBooks Pro.

The location of each consumable item is tracked by the inventory module 166. In preferred embodiments, a bar code reader 116 is used in conjunction with the inventory module 166 to facilitate the tracking of consumable items 34; the inventory module 166 supports the bar coding and tracking of an unlimited number of consumable items 34 with or without distribution approval. Consumable items 34 are also tracked by the module at the job or work item level upon distribution.

Records kept by the inventory module 166 in relation to consumable items 34 include the consumable item 34, quantity, distributing party, receiving party, and signature of the receiving party.

The inventory module 166 is also configured to track the check-out and return of specific company-owned and supplier-owned tools 32 and assets, including the employee checking out the tool 32 or asset. The employee's signature and acknowledgement of receipt are recorded by the module, and preferred embodiments of which have multi-language capability for check-out procedures including the acknowledgement of receipt.

The bar code reader 116 present in preferred embodiments is also used to facilitate tracking of tools 32 and assets, which, like consumables 34, may be bar coded for facilitating tracking by the inventory module 166.

Costs can be assigned to each company-owned or supplier-owned tool 32 and asset through the inventory module 166, which is configured to apply the costs at either the job or the work item level, as determined by the organization.

The inventory module 166 is also configured to track customer-owned consumables 34, tools 32, and assets. Although the module distinguishes between company-owned and customer-owned inventory (that is, consumables 34, tools 32, and assets), the features described above with respect to company-owned consumables 34, tools 32, and assets are also available for use in tracking customer-owned consumables 34, tools 32, and assets.

The human resources management module 168 allows users to track employee hours, benefits, and training. The module records, tracks, and displays alerts to users for training, certifications, badges, etc. at the employee and company level. Employee absences are tracked by the module, as are W-9s, insurance certificates, and signed terms and conditions for vendors, and alerts for renewals of the aforementioned documents are displayed by the module to the appropriate user or users. The human resources management module 168 is also used to track 1099 and 542 forms for independent contractors.

Users also use the human resource management module 168 to prepare, track, and update company benefit information.

The project management module 170 allows users to project anticipated sales, evaluate costs against estimates run reports, plan resources, track e-mail communication by job, and track certificates of completion. The module is configured to assist appropriate users in preparing daily work assignments for employees broken down at the job and work item level. Time sheet entries are also generated through the module, and each employee's hours may be coded by a given employee or by the type of work the employee performed. The project management module 170 is configured to charge labor to active jobs and work items only.

Through the project management module 170, users can capture costs incurred and run profitability reports at the job or work item level at any point during the job. The module also has the ability to generate and process multiple change orders simultaneously and delete, adjust, or add additional work items to a job at the firm fixed price or time and materials level. Through the module, users request and track approval of change orders by customers and assign user-defined tracking numbers and notes to change orders.

The progress module 172 allows users to schedule and monitor the progress of the job. Using the module, users can track and evaluate estimated performance levels versus actual performance levels. Users can also run reports, for any user-defined period, which show progress at the estimated and actual levels for costs and scheduled duration. The module supports integration and monitoring of schedules from Microsoft Office.

The timekeeping module 174 allows users to track each employee's hours worked for jobs and/or work items. In a preferred embodiment, the module integrates with a biometric authentication device 114, such as a fingerprint scanner, which employees use to clock in and out. The system is configured to interface with external accounting software, such as QuickBooks Pro, to aid in tracking employee time.

Through the timekeeping module 174, jobs and work items are assigned to the timecards of individual employees for proper tracking of costs.

The timekeeping module 174 is configured to require supervisory approval of submitted timecards prior to acceptance into the system.

The quality assurance module 176 allows users to maintain a technical library, maintain quality management system (“QMS”) manuals and safety manuals, maintain test and inspection plans (“TIP”), maintain objective quality evidence (“OQE”), checkout tools 32 and track calibration, and perform reporting and auditing to ensure continuous process improvement (CPI).

All processes are truly auditable. The TRAC system 100 was designed with ISO 9000 standards in mind to ensure that users are able to meet the needs of their customers and other stakeholders, while also meeting the statutory and regulatory requirements for a product. The TRAC system 100 is specifically designed to help users conform to NAVSEA Standard Items Requirements 009-04, conduct federal contracting in compliance with their quality management system, and maintain regulatory compliance and project costing.

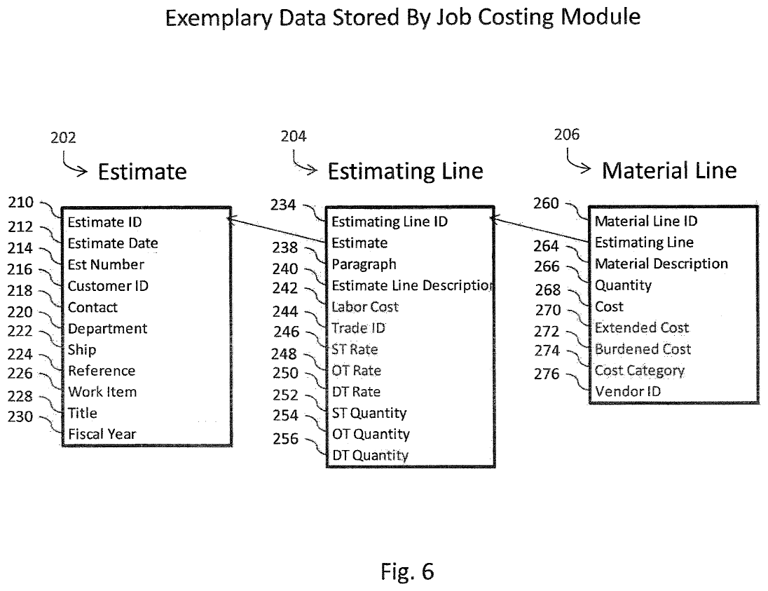

Referring now to FIG. 6, a diagram of exemplary portions of data stored by the job costing module 160 of the TRAC system 100 are shown. The data are stored in the database 136 and entered, viewed, and updated by users through one or more user interfaces provided by the job costing module 160.

Estimate data, in an exemplary embodiment, comprises a row in an estimate database table 202, along with one or more rows in an estimating line table 204 and a material line table 206. Exemplary columns in the estimate table 202 include columns for recording an estimate ID 210, an estimate date 212, a user-defined estimate number 214, a customer ID 216, a contact 218, a department 220, a ship 222—which references a ship 28—a reference 224, a work item 226, a title 228, and a fiscal year 230. In preferred embodiments using an SQL database 136, the first column of any table, when ending in “ID” in the description or figures herein, is implemented as an autoincrementing index, and more particularly as a primary key. This allows for more efficient lookup of rows. In some embodiments, the ID column is not created explicitly with an “autoincrement” key word due to it not being necessary and sometimes being inefficient when creating an autoincrementing primary key in certain databases. The primary key is usually an integer, but in some embodiments a universally unique identifier (“UUID”), such as a UUIDv4 value, is used in conjunction with a database 136 that supports UUIDs as primary keys.

Exemplary columns in an estimating line table 204 include columns for recording an estimating line ID 234, a reference to an estimate via its estimate ID 210, a paragraph 238, an estimate line description 240, a labor cost 242, a trade ID 244—which, in some embodiments, references a functional element 40—a straight time (“ST”) rate 246, an overtime (“OT”) rate 248, a double time (“DT”) rate 250, an ST quantity 252, an OT quantity 254, a DT quantity 256.

Exemplary columns in a material line table 206 include columns for recording a material line ID 260, a reference to an estimating line via its estimating line ID 234, a material description 264, a quantity 266, a cost 268, an extended cost 270, a burdened cost 272, a cost category 274, and a vendor ID 276.

Although some exemplary data in context with some exemplary structure, including tables and columns wherein the related fields reference rows in other tables, it will be apparent to one of skill in the art that many variations on the structure may be made. In particular, the same data is stored in embodiments which use a NoSQL database, but the structure is adapted to the capabilities and nature of the particular form of database 136 used.

Nonetheless, the data, in conjunction with the described exemplary structure or another structure, allows the job costing module 160 to create, store, edit, and delete estimates, including multi-line estimates. In preferred embodiments, the job costing module 160 stores additional data—in separate tables where appropriate to the type of database 136 used, and particularly when an SQL database 136 is used—related to its functionality, including burden rates (both default rates, and rates tied to a particular estimate), comments, attachments, technical manuals and job data.

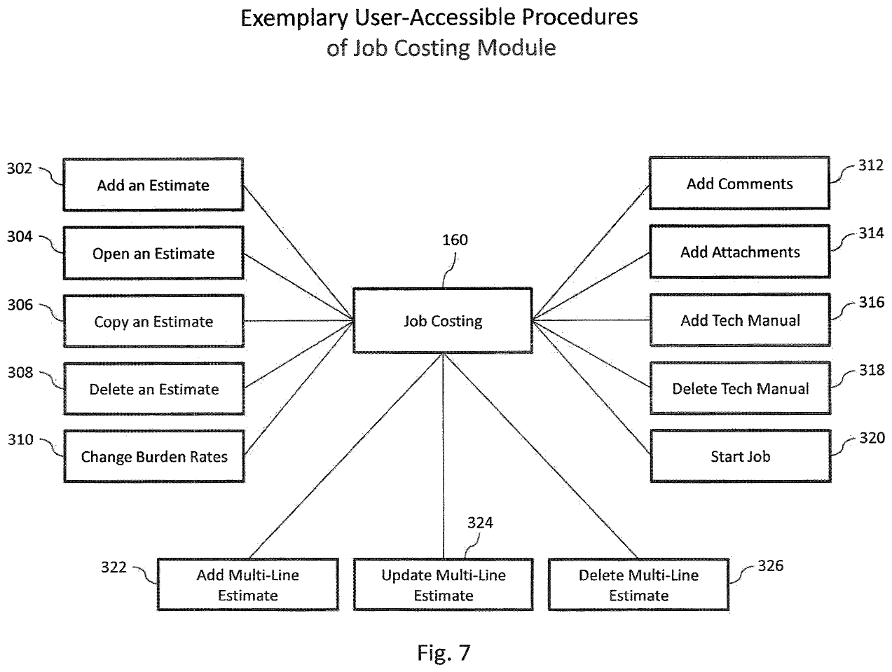

Referring now to FIG. 7, several exemplary user-accessible procedures of the job costing module 160 are illustrated. More particularly, the job costing module 160 provides user interfaces allowing the user to run and interact with each illustrated procedure in order to perform the operations associated with that procedure.

The job costing module 160 contains user interfaces and procedures for adding a new estimate 302, opening and editing an existing estimate 304, copying an estimate 306, deleting an estimate 308, changing burden rates for an estimate 310, adding comments to an estimate 312, adding attachments to an estimate 314, adding technical manuals to an estimate 316, deleting technical manuals from an estimate 318, creating new job from an estimate 320. In order to allow for a simpler interface for simple estimates, some embodiments include separate interfaces for adding a multi-line estimate 322, updating a multi-line estimate 324, and deleting a multi-line estimate 326.

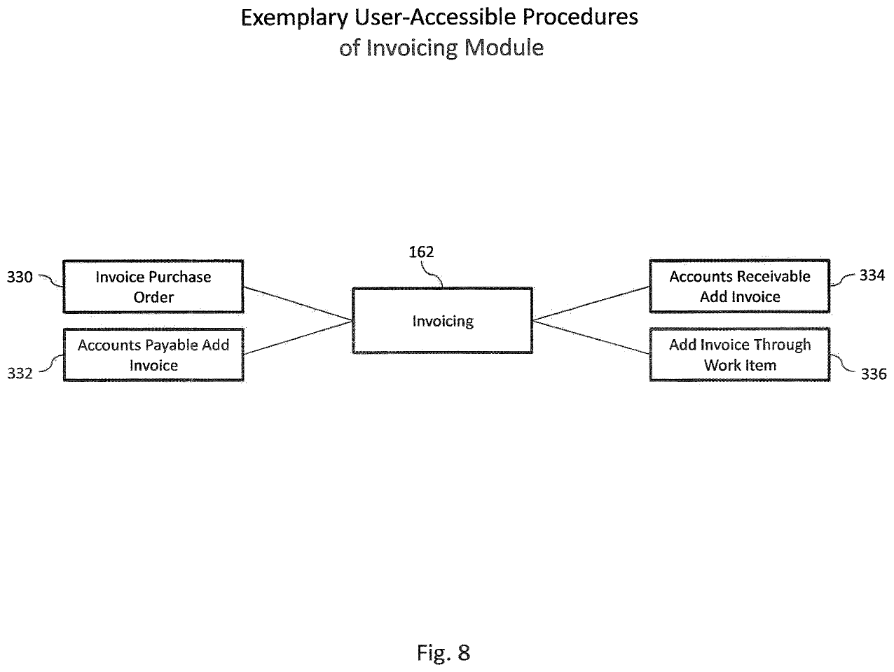

Referring now to FIG. 8, exemplary user-accessible procedures of the invoicing module 162 are illustrated. The invoicing module 162 provides user interfaces to allow a user to execute and interact with each illustrated procedure in order to perform the operations associated with that procedure.

The invoicing module 162 includes an invoice purchase order procedure 330, which opens a user interface window allowing the user to create an invoice from a purchase order. The invoicing module 162 also provides an interface accessible from an accounts payable window for adding an invoice to accounts payable 332. Another interface allows for creating an invoice in accounts receivable 334 based on a purchase order. In the accounts receivable invoice procedure 334, invoices can be created from all line items, or from selected line items in a purchase order. In preferred embodiments, the invoice purchase order procedure 330 and the accounts receivable add invoice procedure 334 comprise the same procedure and user interface, but the procedure may be accessed through at least two different portions from the overall user interface of the TRAC system 100.

Finally, the invoicing module 162 additionally comprises a procedure and corresponding user interface for adding an invoice through a work item 336.

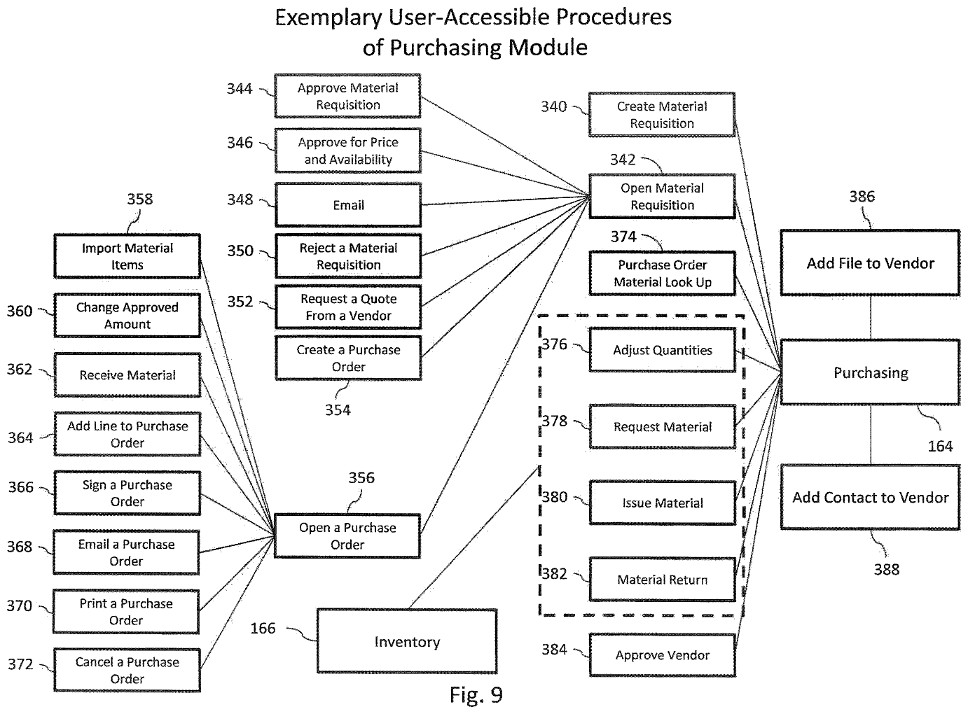

Referring now to FIG. 9, several exemplary user-accessible procedures provided by the purchasing module 164 are illustrated. Each procedure shown has a corresponding user interface provided by the purchasing module 164 in order to allow the user to execute and interact with the procedure in order to perform the operations associated with the procedure.

The purchasing module 164 provides procedures to create a material requisition 340 and to open a material requisition 342.

From the user interface corresponding to opening a material requisition 342, the user can access—as with all procedures, subject to the user's permissions—various procedures that operate on the opened requisition, as illustrated. Those procedures include approving a material requisition 344 and approving a material requisition for price and availability 346. A procedure for emailing a material requisition 348 opens a draft email with the requisition attached as a PDF file. Another procedure for rejecting a material requisition 350 is available from the opened requisition. A procedure for requesting a quote from a vendor 352 allows the request to be printed or attached to a draft email as a PDF file.

Also provided are procedures for creating a purchase order 354 and opening a purchase order 356. From the opened purchase order interface provided by the procedure for opening a purchase order 356, the user can import material items from the material requisition into the purchase order 358, change the approved amount of the material requisition 360, and receive material 362. The receive material procedure 362 and interface allow the user to print a receiving ticket, or attach a PDF file of the receiving ticket to a draft email. From the opened purchase order the user can also add a line to the purchase order 364, sign the purchase order 366 (thereby attaching a dated electronic signature to the purchase order), email a purchase order 368, print a purchase order 370, and cancel a purchase order 372. The email a purchase order procedure 368 opens a window with a draft email message having a PDF file of the purchased order attached.

The purchasing module 164 also provides user-accessible procedures and corresponding user interfaces for looking up purchase order material 374, adjusting quantities of inventoried items 376, requesting material 378, issuing material 380, and returning material 382. The procedures for adjusting quantities of inventoried items 376, requesting material 378, issuing material 380, and returning material 382, allow the TRAC system 100 to keep track of available and in-use material in inventory, and thus form part of the inventory module 166, although in a preferred embodiment they are accessed from a user interface provided by the purchasing module 164. In a preferred embodiment, workstations 112 from which the procedures for issuing material 380 and returning material 382 are commonly accessed are equipped with bar code readers 116. Bar code readers 116 are used with identifying bar codes on inventoried items in order to identify the item being checked out or returned to the procedures. In this way, users can quickly scan an item to identify it in the issuing or returning procedure, thus improving efficiency and speed in tracking the use of material.

Other procedures and corresponding user interfaces provided by the purchasing module 164 allow the user to approve a vendor 384, add a file to a vendor 386 (that is, upload a file to the TRAC system 100 and associate it with a vendor), and add a contact to a vendor 388.

In preferred embodiments, material requisitions, purchase orders, and vendors each have one or more database tables as required to store the associated data.

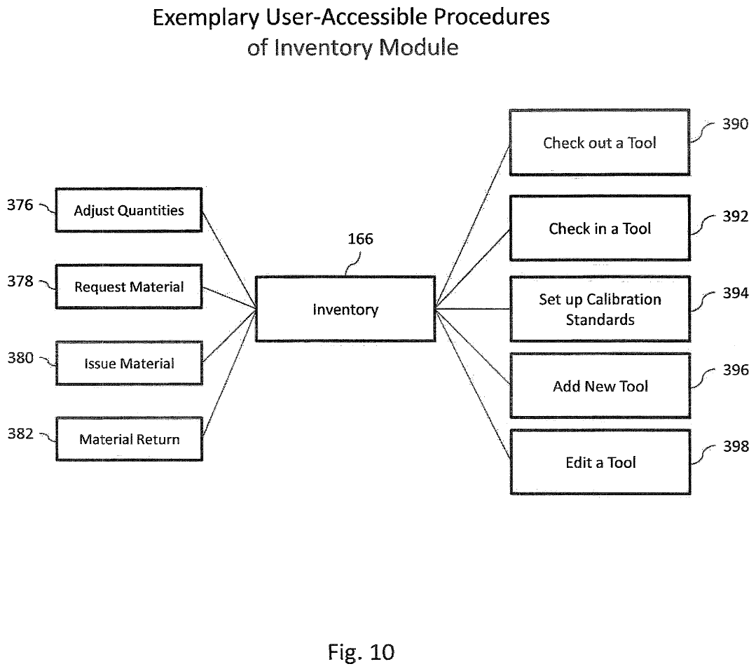

Referring now to FIG. 10, several exemplary procedures provided by the inventory module 166 are illustrated. Each illustrated procedure has a corresponding user interface provided by the inventory module 166 which allows the user to execute and interact with the procedure in order to perform the operations associated with that procedure.

The procedures for adjusting quantities of inventoried items 376, requesting material 378, issuing material 380, and returning material 382 are discussed above in connection with FIG. 9. The inventory module 166 also provides procedures for checking out a tool 390, checking in a tool 392, setting up calibration standards 394, adding a new tool 396, and editing a tool 398. As with the procedures for issuing material 380 and returning material 382, the workstations from which the processes for checking out a tool 390 and checking in a tool 392 have bar code readers 116 attached in a preferred embodiment. The bar code readers 116, used in conjunction with an identifying bar code on each tool 32, allow for the quick and efficient identification of tools in the check out procedure 390 and the check in procedure 392. The add new tool procedure 396 and the edit a tool procedure 398 are also configured to interface with a bar code reader 116 in order to associate a bar code with a new tool 32, or associate a new replacement bar code with an existing tool 32, e.g. in case the bar code associated with an existing tool 32 becomes unreadable or separated from its tool 32.

The set up calibration standards procedure 394 is used to set up options for calibration periodicities, from which is selected a calibration periodicity for each inventoried tool 32. Also set up from the set up calibration standards procedure 394 are calibration standards, from which a calibration standard is selected for each inventoried tool 32.

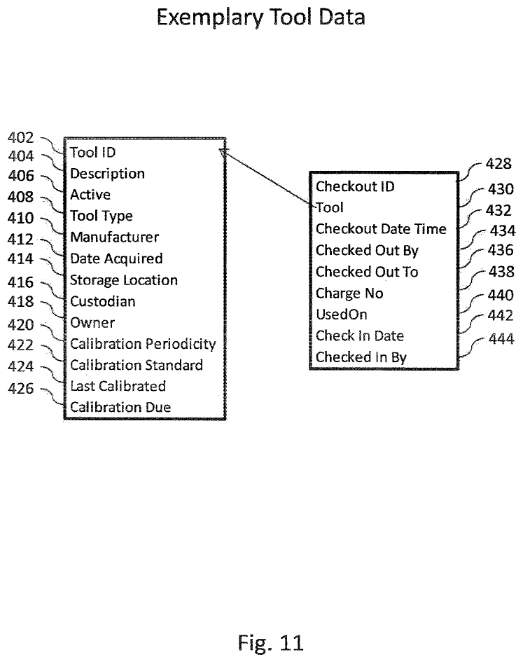

Referring now to FIG. 11, exemplary data stored in connection with an inventoried tool 32 is illustrated. Among the data stored is a tool ID 402, which may comprise one or more of an integer assigned by the database 136 or TRAC server software 138, an alphanumeric identifier assigned by a user, and an identifying bar code (or, more precisely, a digital representation of the identifying bar code attached to the tool 32). In preferred embodiments, as mentioned previously, an integer primary key is used for the first column, though additional columns for a user-defined identifier and a bar code are present. A description 404 of the tool 32 is stored, as is a flag indicating whether the tool is active 406. The data further comprise the tool type 408, manufacturer 410, date acquired 412, storage location 414, custodian 416, owner 418, calibration periodicity 420, calibration standard 422, last calibration date 424, and when the next calibration is due 426. In some embodiments, a separate calibration history table will take the place of the last calibrated 424 column, providing a full calibration history of the tool 32.

Checkouts and check ins of tools 32 are also tracked by the TRAC system 100. In a preferred embodiment using an SQL database 136, a separate table is used with a Checkout ID column 428. A tool column 430 references a tool ID 402 and, in preferred embodiments, is populated automatically by the TRAC system 100 if a user scans a tool 32 with a bar code reader 116 (that is, the user scans the tool's bar code) while a tool check out interface is open. Checkout date 432 (including the time of checkout, autopopulated to the current date and time), checked out by 434, which is autopopulated to the logged in user in a preferred embodiment, checked out to 436, and charge No. 438 columns are also present. A used on column 440 indicates the job for which the tool 32 is being checked out. A check in date column 442 also includes the time in preferred embodiments (that is, check out date 432 and check in date 442 columns are implemented as DATETIME data types in an SQL database). The checkouts table also comprises a checked in by column 444.

The fields corresponding to the check in date column 442 and the checked in by column 444 are not populated at the time a row is created; the row is updated to include this information at the time the tool 32 is checked in. From a tool check in interface, the latest row corresponding to a checkout of the tool 32 is looked up when the tool 32 is scanned with a bar code reader 116. The check in date 442 is autopopulated to the current date and time, and the checked in by column 444 is autopopulated to the logged in user. The user then confirms the autopopulated data, at which point the fields are updated in the database 136.

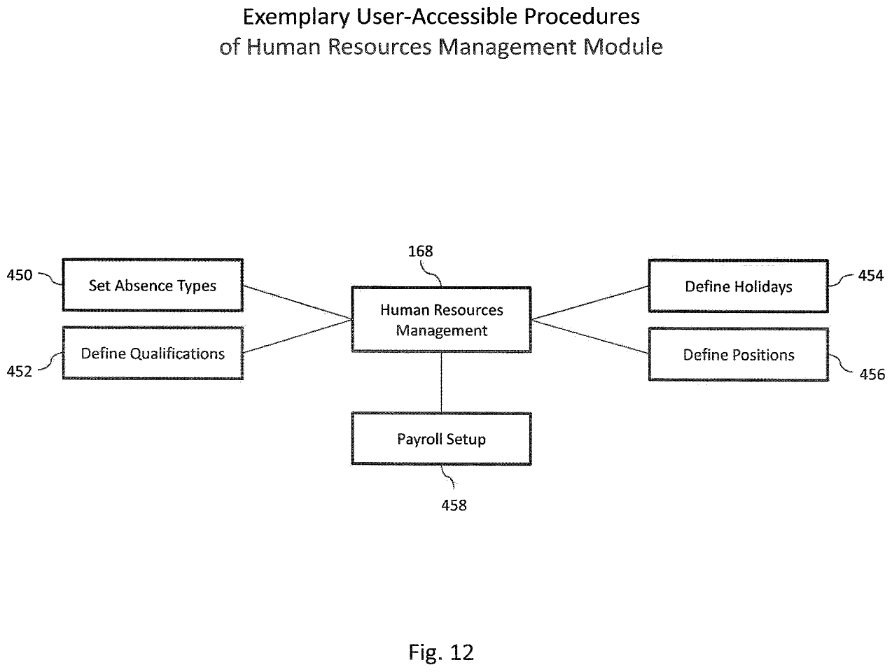

Referring now to FIG. 12, some exemplary user-accessible features of the human resources management module 168 are illustrated. Each illustrated procedure has a corresponding user interface provided by the human resources management module 168 which allows the user to execute and interact with the procedure in order to perform the operations associated with that procedure.

The set absence types procedure 450 allows authorized users to define types of absences. For example, a human resources manager may define absence types including “vacation,” “personal time,” “FML,” “late,” and “holiday.” Employee absences tracked by the TRAC system 100 are then tagged with one of the defined absence types. The absence types procedure 450 also allows an authorized user to enter and save to the TRAC system 100 absence policy text to be included on absence reports.

The define qualifications procedure 452 allows an authorized user to define employee qualifications and associate them with standards and durations. For example, a human resources manager may define qualifications for “10 Hour OSHA,” “Fire Watch,” and “CPR.” Each would be given an associated standard and a duration (e.g. 365 days for a qualification that lasts for one year).

The define holidays procedure 454 is generally used once a year to set up the following year's holidays. For each company-recognized holiday, an authorized user enters a holiday name and a date.

The define positions procedure 456 allows an authorized user to create a list of employee positions, implemented in preferred embodiments as a table with a column for the position. Each employee is associated with a position from the created list.

The payroll setup procedure 458 allows an authorized user to set up pay codes or import them from QuickBooks, including pay codes for straight time rate, overtime rate, double time rate, vacation, holiday, variable rate, and sick time, as well as user-defined pay codes. The payroll setup procedure 458 also allows an authorized user to define shifts, including start time, end time, and lunch start and end times.

Although some exemplary procedures have been illustrated, it will be apparent to one of skill in the art that the human resources management module 168 comprises other procedures, including procedures for creating and maintaining employee records and additional payroll procedures. There is some natural overlap between the human resources management module 168 and the timekeeping module 174, such that certain functions (e.g. approval of time sheets) may be considered to be part of either module.

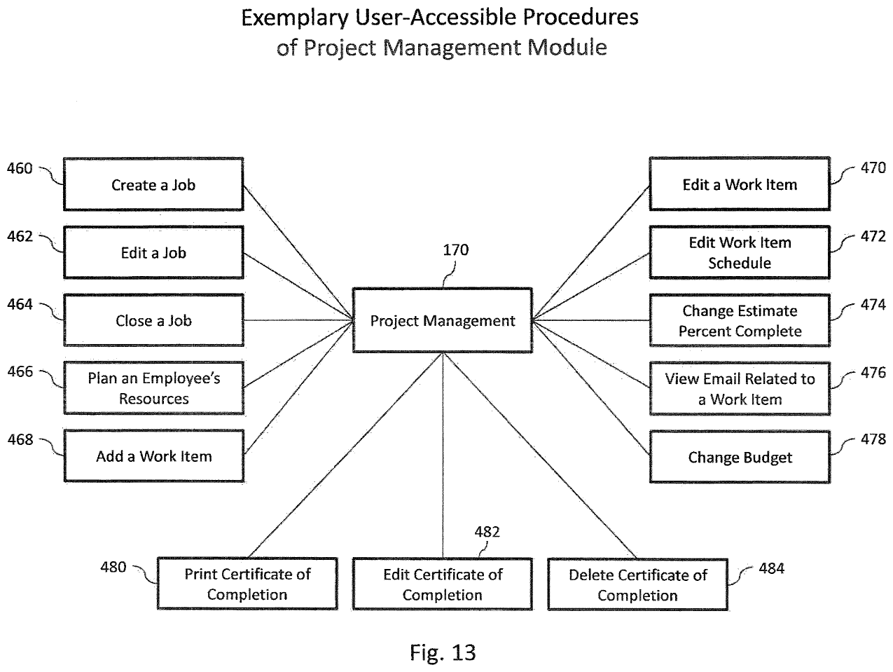

Referring now to FIG. 13, some exemplary user-accessible features of the project management module 170 are illustrated. Each illustrated procedure has a corresponding user interface provided by the project management module 170 which allows the user to execute and interact with the procedure in order to perform the operations associated with that procedure.

The project management module 170 provides procedures for creating a job 460, editing a job 462, and closing out (ending) a job 464. A job may also be created from an estimate through the job costing module 160 as discussed above.

A procedure for planning an employee's resources 466 is configured for assigning employees to tasks for certain work days. An authorized user opens a resource planning user interface provided by the project management module 170, selects an employee, a work date, and a department, enters charge number and pay code data, enters an estimated number of hours, and enters a task to perform. In a preferred embodiment, a user interface element such as a button is configured to copy the previous workday's hours for an employee when engaged by the user (e.g. clicked). This allows for quickly entering an assignment when the employee's hours are the same as the day before.

A job may contain work items, and the project management module 170 provides procedures for adding 468 and editing 470 a work item. A procedure for editing a work item schedule 472 is configured to associate a scheduled start date and a scheduled end date to a work item. The procedure also allows a user to enter an actual start date and a description which the procedure then associates with the work item.

A change the estimate percent complete procedure 474 provides a user estimate from which a project manager can enter a numeric value from 41 to 100 to be associated with a work item as an estimate of the work item's completion.

The project management module 170 additionally provides a procedure for viewing email related to a work item 476. The TRAC system 100 stores copies of all emails related to each work item, and procedure 476 is configured to display all emails related to an open work item.

Another procedure provided by the project management module 170 allows a user to change the original budget 478 associated with a work item. A work item budget comprises fields for “Labor”, “Material”, “Subs”, “Other”, “PO Original”, and “Total”. The user updates each field except “Total”, which is automatically calculated based on the other fields.

The project management module 170 also provides procedures for printing 480, editing 482, and deleting 484 certificates of completion.

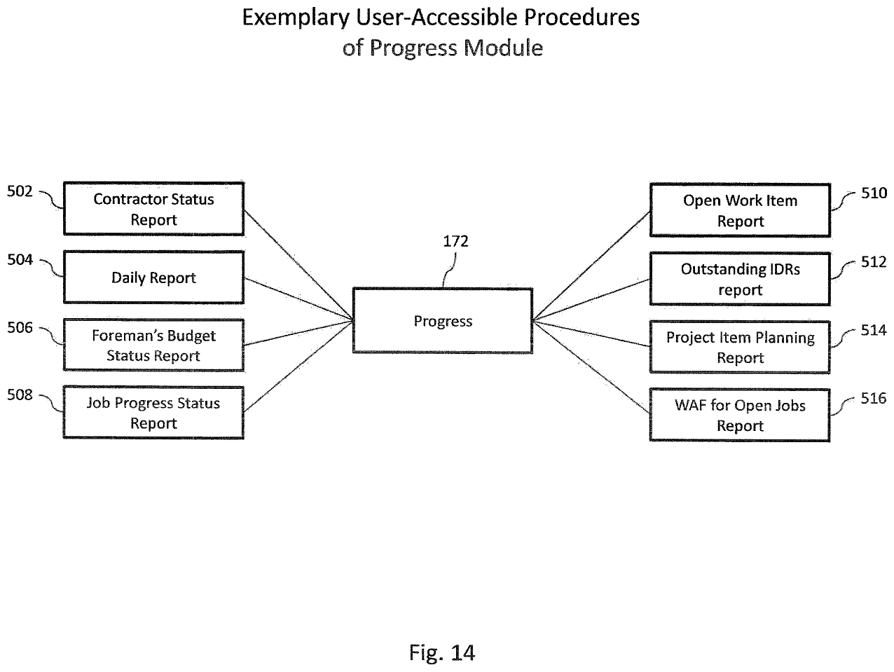

Referring now to FIG. 14, the progress module 172 provides tools for scheduling and monitoring job progress. The progress module 172 prepares and displays various reports, including a contractor status report 502, a daily report 504, a foreman's budget status report 506, a job progress status report 508, an open work item report 510, an outstanding inspection deficiency reports (“IDR”) report 512, a project item planning report 514, and a Work Authorization Form (“WAF”) for open jobs report 516. The open work item report 510 displays all work items that are not closed (i.e., ended).

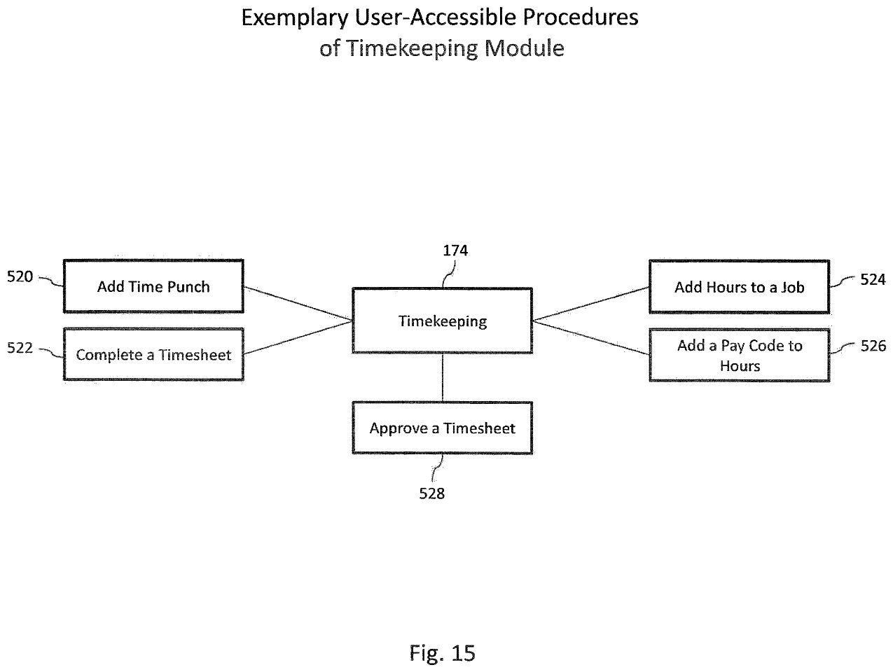

Referring now to FIG. 15, some exemplary user-accessible features of the timekeeping module 174 are illustrated. Each illustrated procedure has a corresponding user interface provided by the timekeeping module 174 which allows the user to execute and interact with the procedure in order to perform the operations associated with that procedure.

Procedures provided by the timekeeping module 174 include procedures for adding a time punch 520, completing a timesheet 522, adding hours to a job 524, adding a pay code to hours 526, and approving a timesheet.

The procedure for adding a time punch 520 clocks in or out an employee. In preferred embodiments, a user may activate it through a biometric authentication device 114 as well as from a graphical user interface provided by the timekeeping module 174. If activated through a biometric authentication device 114, no other interaction is needed to record a time punch. The biometric authentication device 114 identifies the employee, e.g. through a fingerprint, and adds a time punch to the database 136, either clocking in or clocking out the employee.

A timesheet is not always properly completed. For example, if an employee failed to clock in or out at some point, there may be missing time punches on the timesheet. Moreover, an employee may not have been correctly assigned to a job in the schedule, or pay codes may need to be updated. The complete a timesheet procedure 522 allows for such corrections; procedures for adding hours to a job 524 or adding a pay code to hours 526 are, in some embodiments, are accessed through the user interface associated with the complete a timesheet procedure 522.

At the end of a pay period, and after any problems with the timesheet are corrected, a manager approves a user's timesheet through the interface associated with the approve a timesheet procedure 528.

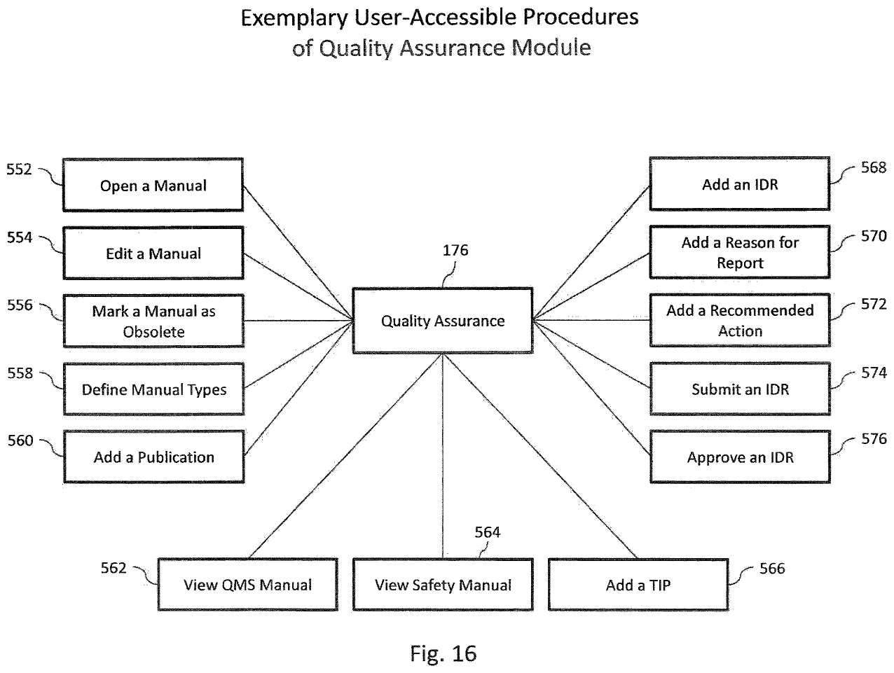

Referring now to FIG. 16, some exemplary user-accessible features of the quality assurance module 176 are illustrated. Each illustrated procedure has a corresponding user interface provided by the quality assurance module 176 which allows the user to execute and interact with the procedure in order to perform the operations associated with that procedure.

The quality assurance module 176 allows users to maintain a library of technical manuals. In order to perform this function, the module comprises procedures for opening a manual 552, editing a manual 554, marking a manual as obsolete 556, defining manual types 558, and adding a publication 560. The editing a manual procedure 554 is configured to change the title, publication data, and publication type at a user's request, and may also comprise the mark a manual as obsolete procedure 556. The add a publication procedure 560 allows a user to upload a technical manual to the library. In a preferred embodiment, new technical manuals are accepted in PDF format.

The quality assurance module 176 also allows users to maintain quality management system (“QMS”) manuals and safety manuals. Procedures are provided for users to view the current QMS manual 562 and to view the current safety manual 564.

An important part of the module is the creation of Test and Inspection Plans (“TIP”). A TIP is created through the add a tip procedure 566.

The TRAC system 100 also maintains Inspection Deficiency Reports (“IDR”), which are associated with TIPs. Procedures are provided to add an IDR 568, add a reason for the IDR 570, add a recommended action in response to the IDR 572, submit an IDR for approval 574, and approve an IDR 576.

Checkout and calibration of tools 32 may also be considered a part of the quality assurance module 176, although it has been discussed above in connection with the inventory module 166.

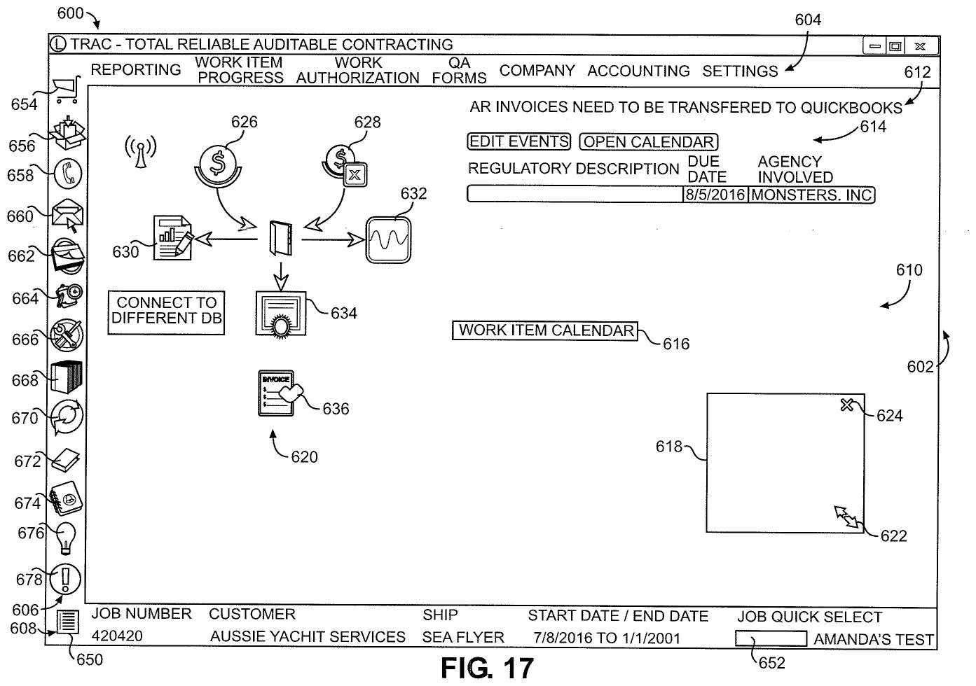

Referring now to FIG. 17, a preferred embodiment of the general user interface 600 of a TRAC system 100 is illustrated. The user interface 600 comprises a desktop 602, a menu bar 604, a toolbar 606, and a job task bar 608.

The desktop 602 largest portion of the user interface 600, and comprises a background 610 and various user interface elements, including accounting notifications 612, a regulatory calendar 614, a work item calendar button 616, user-editable notes 618, and a workflow 620. When engaged by the user, the work item calendar button 616 causes a work item calendar to be displayed.

No user-editable notes 618 are initially present on the desktop 602. The user may add a note 618 by right-clicking any empty portion of the background 610. The number of notes 618 that may be present is limited only by the space on the background 610 from which to create new notes 618. The user may edit a note 618 by clicking on it and typing text. The user may resize the note 618 by clicking on the arrows 622 and dragging the cursor. The user may delete the note 618 by clicking on the x 624. In a preferred embodiment, notes are associated with the user who created them, and do not appear on the desktop when other users are logged in.

The workflow 620 comprises various icons that, when engaged by the user, allow the user to access various interfaces associated with the modules described above. The estimating icon 626 and the multi-line estimating icon 628 allow the user to access interfaces for creating or editing estimates and multi-line estimates, respectively. The IDRs icon 630 allows the user to create and manage Inspection Deficiency Reports. The TIP icon 632 allows the user to manage Test and Inspection Plans. The Certificate of Completions icon 634 allows the user to view, print, and edit certificates of completion. The Invoicing icon 636 allows the user to access procedures associated with the invoicing module 162.

The user interfaces engaged through the workflow 620 operate on the currently open job, the details of which are displayed on the job task bar 608. The currently open job can be changed through the select job button 650 or the job quick select text entry field 652. The job quick select field 652 allows for a job to be quickly looked up by job number, if the job is known. Details shown on the job task bar 608 are the job number, customer, ship, start and end dates, and a brief job description.

The toolbar 606 comprises icons corresponding to purchasing 654, receiving 656, phone list 658, manage email 660, resource planning 662, timesheet entry 664, tool calibration and checkout 666, tech manual library 668, continuous improvement 670, view QMS manual 672, suggest improvement for TRAC 676, and report error for TRAC 678. Most of the icons, when engaged, open up interfaces either directly associated with procedures described above, or from which procedures described above may be run. The phone list 658 allows the user to access addition functionality related to the human resources management module 168, including operations for assigning a shift to an employee, adding an employee absence, adding a qualification to an employee, managing employee hours and vacation, and adding employee reviews or evaluations.

The menu bar 604 also accesses various operations provided by the TRAC system 100, but does so through textual menus rather than icons. Through the menu bar 604, reports, management, and accounting functionality is accessed, as well as interfaces for adjusting various user-configurable settings for the TRAC system 100.

Referring now to FIGS. 18-20, some preferred embodiments of the TRAC system 100 use one or more of a radio-frequency identification (“RFID”) apparatus. The RFID apparatus is capable of reading identification data provided by an identification module comprising an RFID tag; to do so, it uses an RFID reader.

Preferred embodiments use near field communication (“NFC”) RFID readers (“NFC readers”) and NFC RFID tags (“NFC tags”). Near field communication is a communication standard derived from RFID and frequently implemented in mobile phones. An NFC tag may be present in an ID card, or a mobile device having NFC capabilities may be provided with software to cause the mobile device to emulate an NFC tag. The RFID reader functions as a TRAC workstation 112 with a special-purpose TRAC client process 158 configured to acquire timekeeping data and provide it to the TRAC server 110.

Preferred embodiments of the TRAC system 100 will have more than one timekeeping system in order to support clocking in and out of employees in various locations. In many circumstances, it may be desirable to have different types of timekeeping systems, depending on department, team, or employee needs. Therefore, preferred embodiments of the TRAC system 100 support the addition and removal of each of the different RFID timekeeping systems depicted in FIGS. 18-20 and the geo-fencing timekeeping system described in connection with FIG. 21 below. Multiple of each timekeeping system may be used as desired, and the timekeeping systems may be mixed and matched in a TRAC system 100 according to an enterprise's needs.

One preferred embodiment of a timekeeping system is shown in FIG. 18 and generally designated 700. Timekeeping system 700 comprises a fixed RFID reader 710, which in some embodiments is a standalone device, but in others comprises a mobile device 712 affixed to a dock or stand 714 and configured to operate as an NFC reader. Each employee that uses the reader 710 to clock in and out is assigned an ID card 716 having an RFID tag identifying the employee. The employee clocks in or out by placing the ID card 716 next to the RFID reader 710. Alternatively, the employee may have an application on the employee's mobile device which causes the mobile device to act as an NFC tag; the employee would then clock in or out by placing the employee's mobile device next to the RFID reader 710.

Another preferred embodiment of a timekeeping system is shown in FIG. 19 and generally designated 720. Timekeeping system 720 comprises a fixed NFC tag 722. An employee's mobile device 728 is equipped with software configured to communicate with the TRAC system 100 to clock the employee in or out upon reading the fixed NFC tag 722. Different NFC tags 722 may be present in different locations, and the mobile device 728 further communicates to the TRAC system 100 which NFC tag 722 the employee used to clock in. Timekeeping system 720 is particularly, though not exclusively, useful when an employee may be assigned to report to a different location for each project, or otherwise may be expected to report to different locations on different days.

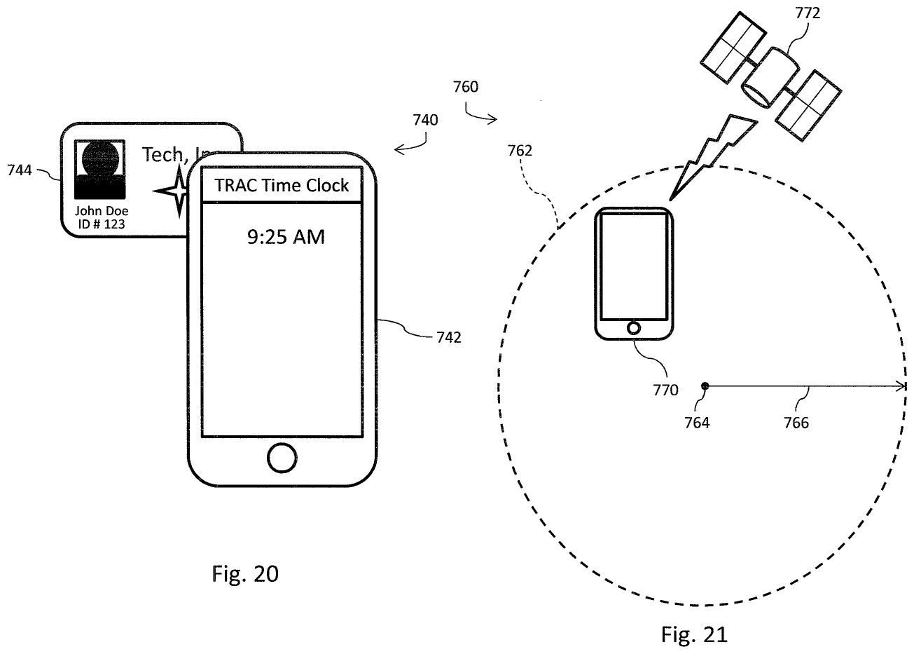

FIG. 20 shows another preferred embodiment of a timekeeping system, which is generally designated 740. Timekeeping system 740 comprises a mobile device operating as an NFC reader. This embodiment may be implemented by providing each supervisor (e.g. a foreman or manager) with a mobile device configured to operate as NFC reader 742, or installing software on the supervisor's mobile device to cause it to operate as NFC reader 742. The supervisor is then able to clock his or her supervised employees in or out with the mobile device by having each employee place that employee's ID card 744, which is equipped with an NFC tag, up against the mobile device. This allows for the decentralization of employee clocking in and out, increasing efficiency and flexibility: A team could report to a different (perhaps offsite) location for a particular project, and still be able to clock in and out as normal. As with timekeeping system 700 of FIG. 18, employees may be provided with mobile software configured to cause their mobile device to emulate an NFC tag and operate as ID card 744; in this way, an employee would use a mobile device instead of an ID card to clock in and out of timekeeping system 740.

Referring now to FIG. 21, a preferred embodiment of a timekeeping system is shown and generally designated 760. Timekeeping system 760 may be used alongside other timekeeping systems according to the needs and desires of the enterprise using the TRAC system 100.

Timekeeping system 760 comprises a geo-fence having a perimeter 762. In some embodiments, perimeter 762 is defined based on a predetermined set of borders, and may take on any desired shape. In a preferred embodiment, perimeter 762 is defined by a radius 764 from a predetermined point 766, forming a circular geo-fence.

Employees using timekeeping system 760 are equipped with a location-aware device 770. Location-aware device 770 communicates with a location-based service 772 in order to determine the employee's location. When an employee enters the perimeter 762, the employee is clocked in. When an employee leaves the perimeter 762, the employee is clocked out. Thus no particular activity on the part of the employee is necessary to clock in or out, other than entering or leaving the work site.

In a preferred embodiment, location-aware device 770 comprises a mobile phone, and location-based service 772 comprises assisted GPS (“AGPS”), although GPS alone and other positioning systems known in the art are sometimes used.

In an alternative embodiment, location-based service 772 comprises a Wi-Fi access point. The perimeter 762 is the range of the Wi-Fi access point, and location-aware device 770 is configured to connect automatically to the Wi-Fi access point of location-based service 772. Once connected, the location-based service 772 recognizes the location-aware device 770 (e.g. by a MAC address), and clocks in the employee. Alternatively, the location-aware device 770 may be configured to communicate with the TRAC system 100 to clock in the employee once connected to the Wi-Fi access point of location-based service 772.

While there have been shown what are presently considered to be preferred embodiments of the present invention, it will be apparent to those skilled in the art that various changes and modifications can be made herein without departing from the scope and spirit of the invention.

What is claimed is:

1. An auditable networked enterprise oversight system, comprising:
a server having a database;
one or more workstations;
a TRAC system implemented by the server and the one or more workstations, the TRAC system comprising a plurality of modules; and
one or more peripheral devices, each peripheral device attached to a workstation of the one or more workstations and configured to interact with at least one module of the plurality of modules,
wherein the TRAC system is configured to track physical inventory, track employee work hours, schedule jobs, and monitor job progress.

2. The auditable networked enterprise oversight system as recited in claim 1,
wherein the one or more peripheral devices comprises a bar code reader configured to interact with an inventory module of the TRAC system to track physical inventory by reading bar codes attached to the physical inventory.

3. The auditable networked enterprise oversight system as recited in claim 1,
wherein the one or more peripheral devices comprises timekeeping apparatus configured to interact with a timekeeping module of the TRAC system to track employee work hours.

4. The auditable networked enterprise oversight system as recited in claim 3,
wherein the timekeeping apparatus comprises RFID means for tracking employee work hours.

5. The auditable networked enterprise oversight system as recited in claim 4,
wherein the RFID means comprises a mobile device configured to act as a NFC reader.

6. The auditable networked enterprise oversight system as recited in claim 3,
wherein the timekeeping apparatus comprises geofencing means for automatically tracking employee work hours.

7. The auditable networked enterprise oversight system as recited in claim 6,
wherein the geofencing means comprises GPS-based geofencing means.

8. The auditable networked enterprise oversight system as recited in claim 6,
wherein the geofencing means comprises Wi-Fi access point based geofencing means.

9. An auditable electronically managed enterprise, comprising:
infrastructure comprising buildings and vehicles;
inventory comprising consumable inventory and tools;
employees; and
an electronic oversight system, comprising:
a TRAC system comprising:
a job costing module;
an invoicing module;
a purchasing module;
an inventory module;
a human resources management module;
a project management module;
a progress module;
a timekeeping module; and
a quality assurance module,
a bar code reader configured to interact with the inventory module, and
timekeeping apparatus configured to interact with the timekeeping module,
wherein each item of the inventory has a bar code readable by the bar code reader in order to enable the inventory module to track use of the inventory, and
wherein the timekeeping apparatus is configured to identify employees entering and leaving a work site in order to enable the timekeeping module to track work hours.

10. The auditable electronically managed enterprise as recited in claim 9,
wherein the invoicing module, the inventory module, and the timekeeping module are configured for integration with external accounting software.

11. The auditable electronically managed enterprise as recited in claim 9,
wherein the progress module is configured to prepare and display a plurality of reports.

12. The auditable electronically managed enterprise as recited in claim 9,
wherein the timekeeping apparatus comprises a biometric authentication device.

13. The auditable electronically managed enterprise as recited in claim 9,
wherein the timekeeping apparatus comprises RFID means for tracking employee work hours.

14. The auditable electronically managed enterprise as recited in claim 9,
wherein the timekeeping apparatus comprises geofencing means for automatically tracking employee work hours.

15. An auditable electronically managed shipyard, comprising:
at least one crane;
at least one slipway or drydock;
at least one building;
tools;
consumables;
employees; and
a TRAC system configured for management of the shipyard and at least partially housed in at least one building of the at least one building,
wherein the shipyard is capable of receiving ships to perform one or more jobs selected from the group consisting of:
welding;
machining;
pipefitting;
electrical work;
painting;
rigging; and
carpentry,
wherein the TRAC system comprises:
a server having a database;
one or more workstations;
a plurality of modules implemented by the server and the one or more workstations; and
one or more peripheral devices, each peripheral device attached to a workstation of the one or more workstations and configured to interact with at least one module of the plurality of modules, and
wherein the TRAC system is configured to track physical inventory, track employee work hours, schedule jobs, and monitor job progress.

16. The auditable electronically managed shipyard as recited in claim 15,
wherein the TRAC system is configured to integrate with external accounting software.

17. The auditable electronically managed shipyard as recited in claim 15,
wherein the plurality of modules comprises an inventory module, wherein the one or more peripheral devices comprises a bar code reader, and
wherein the bar code reader is configured to read bar codes identifying the tools and the consumables and interact with the inventory module in order to track the use of the tools and the consumables.

18. The auditable electronically managed shipyard as recited in claim 15,
wherein the plurality of modules comprises a timekeeping module,
wherein the one or more peripheral devices comprises a biometric authentication device, and wherein the biometric authentication device is configured to identify the employees and interact with the timekeeping module to track employee work hours.

19. The auditable electronically managed shipyard as recited in claim 15,
wherein the plurality of modules comprises a timekeeping module,
wherein the one or more peripheral devices comprises RFID means for identifying the employees, and wherein the RFID means for identifying the employees is configured to interact with the timekeeping module to track employee work hours.

20. The auditable electronically managed shipyard as recited in claim 15,
wherein the plurality of modules comprises a timekeeping module,
wherein the one or more peripheral devices comprises geofencing means for identifying the employees, and wherein the geofencing means for identifying the employees is configured to interact with the timekeeping module to track employee work hours.
